(19) United States
(12) Patent Application Publication
(10) Pub. No.: US 2006/0006726 A1
(43) Pub. Date: Jan. 12, 2006

(54) Height adjustable dumping apparatus

(76) Inventor: William Ralph Garvey, Riverside, CA (US)

Correspondence Address: Mr. Roy and Ronica Hickey, 1070 Raquel Road, Norco, CA, 92860, US

(21) Appl. No.: 10/890,306

(22) Filed: Jul. 12, 2004

(51) Int. Cl. B62B 1/00

(52) U.S. Cl. 298/2

(57) ABSTRACT

A holding container is hingably connected to a platform. Expanding arm pairs are connected to the platform and a frame. Wheels are connected to the frame. The frame has a support portion and a handle portion. A motor linked to the expanding arm pairs raises and lowers the holding container. A rechargeable power source is used to drive the motor. A controller is connected to the motor and the rechargeable power source to control the motor. The holding container can rotate from the platform to dump contents within the holding container.

### BACKGROUND

1. Field

The embodiments relate height adjustable dumping apparatus, and more particularly to dumping apparatus that can manually or automatically be lifted to dump contents in a dumpster.

2. Description of the Related Art

In commercial or residential settings that include a horse or horses, to keep the environment safe and clean the corals/barn/stalls need to be cleaned often to remove manure. Trash removal companies typically provide large dumpsters for the removal of horse manure. FIG. 1 illustrates a typical trash dumpster provided for manure removal.

Manure is typically collected first by raking/shoveling and placing it in a wheel barrel or similar device. FIGS. 2A-B illustrate typical collection holding devices. Once the manure is collected and placed in a wheeled holding device (such as illustrated in FIGS. 2A-B), the manure must then be placed in a dumpster (such as the dumpster illustrated in FIG. 1).

FIGS. 3A-B illustrate how a typical manure holding device is used to move the manure into a dumpster. As illustrated in FIGS. 3A-B, if the manure holding devices are filled, it typically takes two persons to lift and dump the contents into a dumpster. Also, depending on the weight of the contents, more trips may be necessary. Besides lifting the manure holding device so contents can be dumped in a dumpster, many individuals simply move the device to a dumpster and use a shovel to empty contents from the device into a dumpster.

FIG. 4 illustrates another way for assisting in moving manure from a holding device into a dumpster. A ramp can be built that is either at the level of a dumpster's top opening or just below. A person can then roll the holding device up the ramp and then dump the contents into the dumpster. A problem with this method is the ramp takes up space and some environments may not have room for a ramp.

### SUMMARY

One embodiment includes a holding container hingably connected to a platform. Many expanding arm pairs are connected to the platform and a frame. Wheels are attached to the frame. The frame has a support portion and a handle portion. A motor is linked to the expanding arm pairs to raise and lower the holding container. A rechargeable power source is included to drive the motor. A controller is connected to the motor and the rechargeable power source to control the motor. The holding container can rotate from the platform to dump contents within the holding container.

Another embodiment includes a holding container hingably connected to a platform. Many expanding arm pairs are connected to the platform and a frame. Wheels are attached to the frame. The frame has a support portion and a handle portion. A jack is connected to the expanding arm pairs to raise and lower said holding container. The holding container can rotate from the platform to dump contents within the holding container.

Still another embodiment is a wheel barrel including a holding container hingably connected to a platform. Many expanding arm pairs are connected to the platform and a frame. A wheel set is connected to the frame. The frame has a support portion and a handle portion. The support portion to rest on a surface. A motor is linked to the expanding arm pairs to raise and lower the holding container. A rechargeable power source drives the motor. A controller is connected to the motor and the rechargeable power source to control the motor. The holding container can rotate from the platform to dump contents within the holding container.

### BRIEF DESCRIPTION OF THE DRAWINGS

The embodiments of the invention are illustrated by way of example and not by way of limitation in the figures of the accompanying drawings in which like references indicate similar elements. It should be noted that references to “an” embodiment of the invention in this disclosure are not necessarily to the same embodiment, and they mean at least one.

FIG. 1 illustrates a typical trash dumpster.

FIG. 2A illustrates a typical collection holding device.

FIG. 2B illustrates another typical collection holding device.

FIG. 3A illustrates a typical way to empty contents of a holding device into a dumpster.

FIG. 3B illustrates a typical way to empty contents of a holding device into a dumpster.

FIG. 4 illustrates a ramp for assisting in moving content from a holding device into a dumpster.

FIG. 5A illustrates a side view of an embodiment of a dumping apparatus.

FIG. 5B illustrates a front view of an embodiment of a dumping apparatus.

FIG. 5C illustrates a side view of an embodiment of a dumping apparatus in a raised position.

FIG. 5D illustrates a side view of an embodiment of a dumping apparatus in a dumping position.

FIG. 6A illustrates an embodiment of a dumping device having two sets of expanding arm pairs on each side of the dumping device.

FIG. 6B illustrates an embodiment of a dumping device having three sets of expanding arm pairs on each side of the dumping device.

FIG. 7A illustrates a side view of an embodiment of a dumping device including a jack.

FIG. 7B illustrates a front view of an embodiment of a dumping device including a jack.

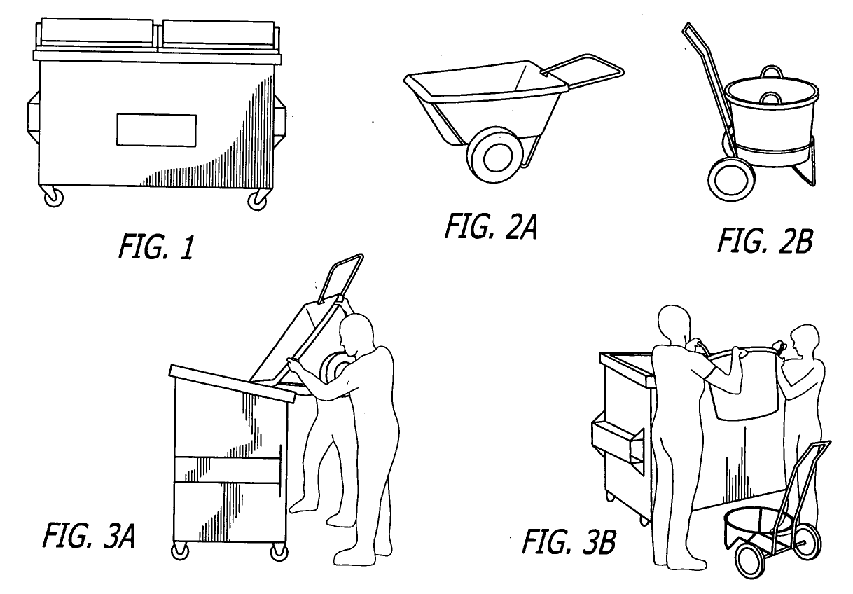

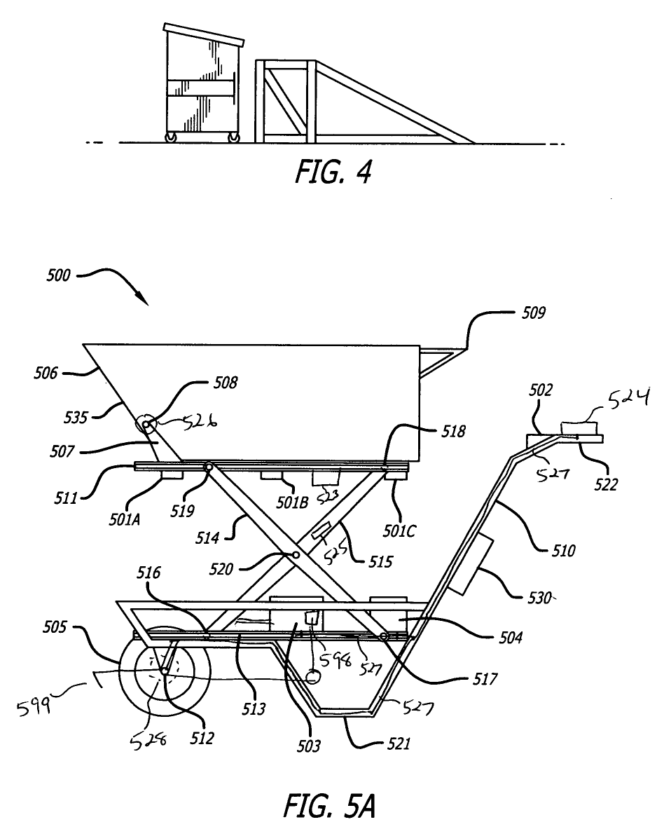

### DETAILED DESCRIPTION

The Embodiments discussed herein generally relate to a height adjustable dumping apparatus. Referring to the figures, exemplary embodiments will now be described. The exemplary embodiments are provided to illustrate the embodiments and should not be construed as limiting the scope of the embodiments.

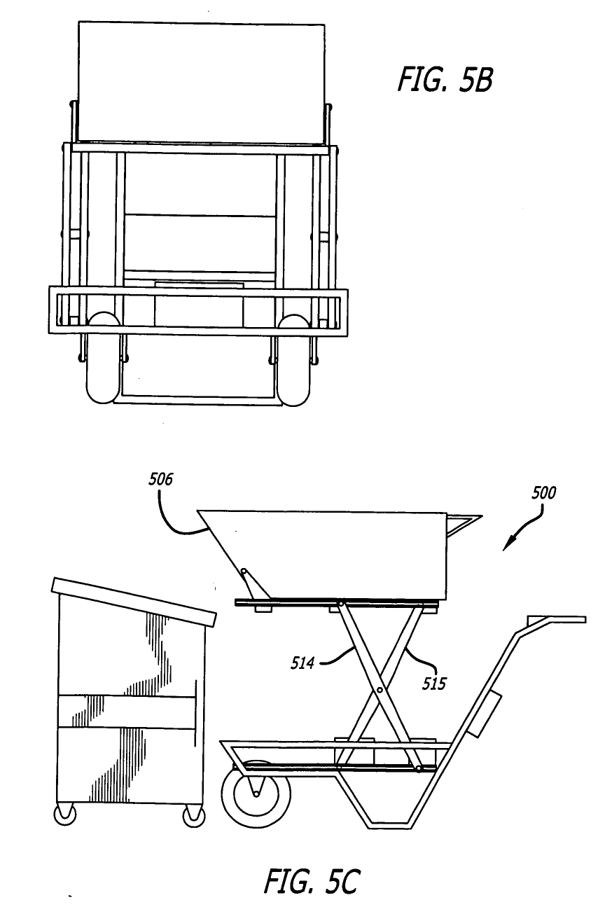

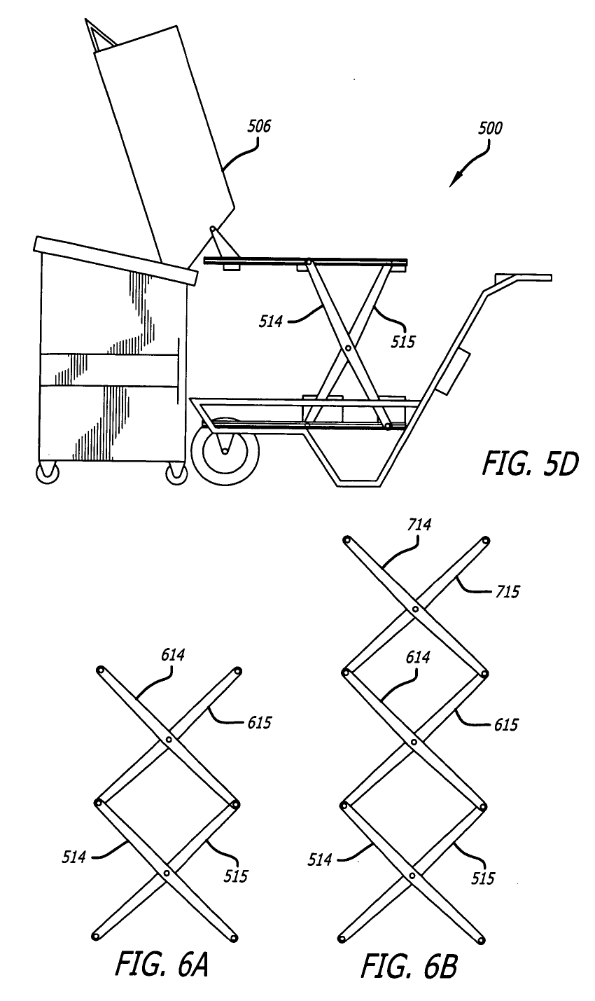

FIG. 5A illustrates a side view of an embodiment of a dumping apparatus. FIG. 5B illustrates a front view of the embodiment illustrated in FIG. 5A. Dumping apparatus 500 includes holding container 506 that is hingably connected to platform 511. In one embodiment holding container 506 is shaped as typical wheel barrel containers. In other embodiments, holding container 506 is shaped as a dumping portion in a dump truck. One should note that different shapes can be implemented for holding container 506 without changing the scope of the embodiments.

In one embodiment platform 511 has a plurality of rubber stoppers attached to its top that contact with holding container 506 when holding container 506 is in the filling position (i.e., at rest on top of platform 511 and not in the dumping position). The number of stoppers (illustrated as 501a-501c) can vary, such as three stoppers, four stoppers, six stoppers, etc. The rubber stoppers cushion holding container 506 from platform 511 in case of holding container 506 being slammed down on platform 511.

In one embodiment pairs of expanding arms 514 and 515 (i.e., there are opposing pairs of expanding arms 514 and 515 on each side of dumping apparatus 500, therefore four expanding arms total) are connected to platform 511 and frame 510 at opposing sides of holding container 506. It should be noted that other embodiments can have more sets of expanding arm pairs coupled to ends of each other to increase the maximum height holding container 506 can be lifted (e.g., 2 sets, three sets, etc.; see FIGS. 6A-B illustrating two sets and three sets of expanding arm pairs, respectively). In one embodiment, at least two wheels 505 are attached to frame 510 and have an axle 512 and standard connection means, such as nuts and bolts, pins, clips, etc.

In one embodiment frame 510 has support portion 521 and handle portion 522. Support portion 521 comes in contact with a surface (e.g., the ground) when apparatus 500 is not being moved from one place to another. It should be noted that holding container 506 is angled such that the portion closest to the wheels is elevated over the portion closest to handle 522 when apparatus 500 is at rest. This is so when a person moves apparatus 500 by lifting on handle 522 holding container 506 will be level. In another embodiment, support portion 521 is modified with an axle and a set of wheels coupled to the axle (not shown). In this embodiment, two sets of wheels are used to move dumping apparatus 500. Also included in this embodiment are wheel locks coupled to each wheel to prevent movement when necessary. In another embodiment a small electrical motor is coupled to the rear axle, rechargeable power source 504 and controller 502. In this embodiment, power is supplied to the motor to drive the rear wheels. This assist a person in moving dumping apparatus 500. Note that the motor is gear driven and will only supply enough power to the rear axle to move dumping apparatus between two to four miles per hour.

In one embodiment motor 503 is linked to expanding arms 514 and 515 to raise and lower holding container 506. Motor 503 can have standard linking to expanding arms 514 and 515, such as screw drive, gears, etc. In one embodiment motor 503 is a standard electric motor sized to lift a full holding container 506 with contents, such as manure, dirt, sand, etc. In another embodiment, motor 503 is a hydraulic motor having an electric pump sized to lift a full holding container 506 with contents, such as manure, dirt, sand, etc. In one embodiment rechargeable power source 504 is wired to motor 503 to drive motor 503. Rechargeable power source 504 is a rechargeable battery sized to power motor 503 multiple times without having to be recharged. In one embodiment controller 502 is wired to motor 503 and rechargeable power source 504 to control motor 503. In one embodiment controller 502 includes a key switch to control on/off and switches to control lifting of holding container 506. In another embodiment controller 502 as a keypad for entering a code to prevent unauthorized use of apparatus 500. In one embodiment, controller 502 has a display readout and sound chip to inform a user of status, such as maximum weight, maximum lift, unbalanced load, power source status, etc. Standard means for measuring weight are connected to platform 511 or base 513 and a predetermined maximum weight is stored in a memory in controller 502. A processor in controller 502 compares the measured weight with the predetermined maximum weight to alert users of content status. In one embodiment, the predetermined weight is given a buffer of five or ten percent for safety reasons in case an over-limit point is reached.

In one embodiment the unbalanced load alert is given when weight measured at one portion of platform 511 is greater than a predetermined ratio when compared with a weight measurement at least one other portion of platform 511. Two or more weight sensing elements can be compared to determine if the load in holding container 506 is unbalanced or not. A processor than compares the measured weights and calculates a weight ratio among the measured areas. The processor than retrieves a predetermined ration from a memory and compares the measured ratio with the predetermined ratio. If the predetermined ratio is exceeded an alert is given (sound/light) to inform users. In one embodiment, a balanced signal is given when the load is properly balanced (e.g., light, words in a display, etc.). This makes it safer for holding container 506 to be raised with a tip-over condition being minimized.

In another embodiment, controller 502 has a switch to control locking of wheels 505 by conventional means, such as an electric lever, friction means to come in contact with wheels 503, etc. In another embodiment, a mechanical wheel lock is located at wheels 505 to prohibit wheel rotation.

In one embodiment holding container 506 can rotate from platform 511 to dump contents within holding container 506. In one embodiment holding container 506 has one or more handles 509 attached to allow a place for a person to grip holding container 506 to rotate holding container 506 away from platform 511 for dumping of contents. In one embodiment holding container 506 has a quick release mechanism to allow holding container 506 to lock into place with/release from platform 511. In this embodiment, the quick release mechanism can be standard components, such as spring locks, locking pins, clips, clasps, etc. In one embodiment, the quick release mechanism is located toward the rear of holding container 506 (i.e., portion closest to handle 522).

In one embodiment expanding arms 514 and 515 are slidably connected to platform 511 and base 513, which is connected to frame 510. In this embodiment expanding arms 514 and 515 have a pivoting pin 520 that allows expanding arms 514 and 515 to slide by one another. Expanding arms 514 and 515 each have an end (517 and 516, respectively) connected to base 513. Expanding arms 514 and 515 each have an another end (519 and 518, respectively) connected to platform 511. In one embodiment one of the ends of expanding arms 514 and 515 (516, 517, 518, 519) are connected with a pivoting pin (i.e., immobile but allowed to change the angle of an expanding arm) while the opposing ends are allowed to slide for expansion and contraction. In this embodiment, the expanding arms operate in a scissors type of action.

In one embodiment an “arm blocked” sensor is attached to apparatus 500 to stop motor 503 if an overstrain condition is sensed, such as something stuck between the expanding arms, a persons hand/arm is in the way, etc. In one embodiment an optical sensor is used to determine if any of the expanding arms have an obstruction. Standard sensors are used in this embodiment that are similar to those used in elevators and automatic garage doors with electric openers.

In one embodiment holding container 506 is able to rotate between 90° and 135° in relation to platform 511. In another embodiment holding container is able to rotate between and 90° and 225° in relation to platform 511. That is holding container 506 is first released from at least one end of platform 511 and holding container can rotate via hinge 507 (connected to platform 511) that has a pin 508 that can rotate within hinge 507. The rotation limits are controlled by means, such as a brake pin connected to either hinge 507 or holding container 506, by holding container 506 coming into contact with platform 511, etc. FIG. 5C illustrates apparatus 500 in the raised position before holding container 506 is rotated into dumping position. As illustrated, expanding arm pair 514 and 515 (and opposing expanding arm pair) are fully expanded where the top portions and bottom portions of each pair of expanding arms are at their closest position toward each other. FIG. 5D illustrates apparatus 500 with holding container 506 rotated away from platform 511 and in the dumping position.

In one embodiment, counterbalance holder 530 is coupled to frame 510. In this embodiment, weights can be loaded onto counterbalance holder 530 to counterbalance a load when dumping so apparatus 500 does not tip over when in the dumping position. In another embodiment, trap door 535 allows content within holding container 506 to rapidly exit when a locking pin is removed. This embodiment does not include counterbalance holder 530, as there is not a need since content will empty upon holding container 506 being rotated to a dumping position. That is, upon initial rotation, content within holding container 506 will exit, thus relieving the weight within holding container 506.

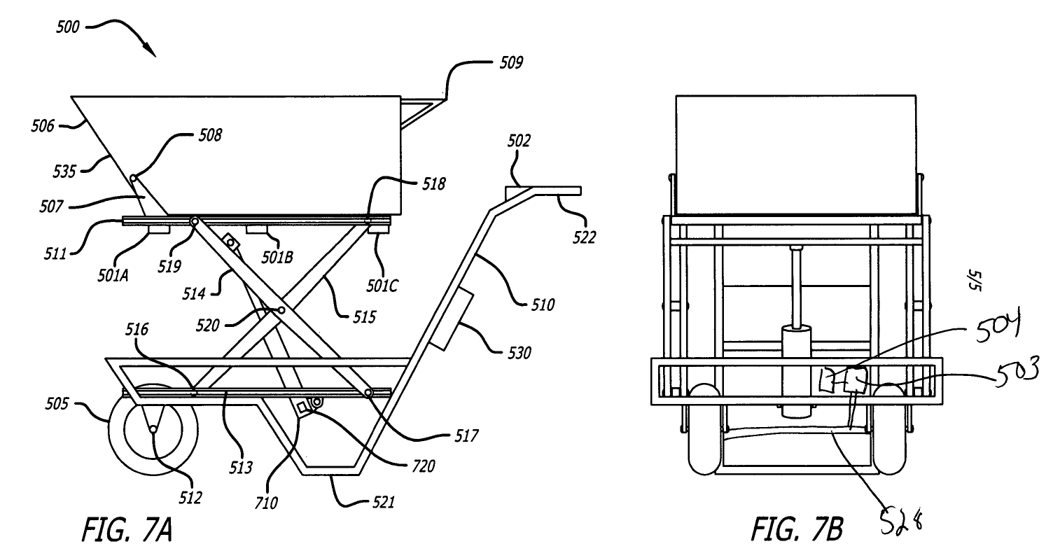

FIG. 7 illustrates an embodiment similar to the embodiments illustrated in FIGS. 5A,B-6B including jack 710 connected expanding arm pairs 514 and 515 to raise and lower holding container 506. In one embodiment jack 710 is a hydraulic jack that is pumped mechanically with a jack handle (not shown) inserted into handle insertion portion 720. In another embodiment a foot pedal is connected to jack 710 and is pumped by a user with a foot to raise platform 511. A release valve controls the release of pressure to allow platform 511 to be lowered from a raised position.

In another embodiment jack 710 is a scissor jack (i.e., screw drive) that is raised by rotating a handle. Jack 710 is similar to standard jacks used to raise and lower objects, such as cars, motorcycles, etc.

In the embodiments illustrated in FIG. 7, jack 710 replaces motor 503 and there is no need for a controller with switches connected to motor 503 and power source 504. In these embodiments a smaller rechargeable battery is used to power alerts and sensors, e.g., unbalanced load sensor and alerts, overweight condition sensor and alert, a processor connected with memory, and blocked expanding arm sensor and alert.

Holding container 506 can be made by typical processes, such as pultrusion, injection molding, etc. Holding container 506 can be made from materials, such as hardened plastic, fiberglass, aluminum, metal alloys, etc. Frame 510 and platform 511 can be made from aluminum, metal alloys, hardened fiberglass, etc.

The above embodiments have holding container 506 positioned with platform 511 and base 513 such as not to be overloaded above wheels 505 when holding container 506 is rotated to dump its contents. That is, the above embodiments will be balanced so as not to tip over when dumping contents.

One embodiment includes a lifting means for lifting the rear end of holding container 506 (i.e., the end closest to handle portion 522). In one embodiment, the means includes a jack (hydraulic or scissor type) that raises holding container 506 to at least a 45° in relation to platform 511 when a person mechanically pumps the jack with a handle/foot pedal or turns a handle. With the holding container raised it is easier for a person to dump the contents into a dumpster by themselves, as they will have more leverage as opposed to holding container not being raised. In another embodiment, the lifting means has an electric motor with either a screw drive or hydraulic pump. The jacks/motors in these embodiments do not need to be capable of lifting as much as the jacks/motors connected to the expanding arms as the holding container is only lifted a minimum distance at one end. In the case of the electric motor/electric hydraulic pump, these are connected to power source 504 and controlled by controller 502.

The above embodiments make it easier for a person(s) to unload contents in a holding container into a dumpster. By using the above embodiments, a person can easily dump contents by themselves without needing another person to raise the holding container to be able to dump contents in a standard dumpster. By simply pressing a button/moving a switch or jacking up the holding container, a person can raise the holding container to position it above a dumpster. The holding container then can be rotated to dump the contents.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

1. An apparatus comprising:
a holding container hingably coupled to a platform,
a plurality of expanding arm pairs coupled to said platform and a frame, and
a plurality of wheels coupled to said frame, said frame having a support portion and a handle portion,
wherein said plurality of expanding arm pairs raise and lower said holding container, said plurality of expanding arm pairs raise said platform to at least a height of a dumpster and said holding container can rotate from said platform to dump contents within said holding container, and said holding container can rotate from said platform greater than 90°.

2. The apparatus of claim 1, further comprising:
at least one handle coupled to said holding container, and
a wheel lock to lock at least one of the plurality of wheels in place.

3. The apparatus of claim 1, said plurality of expanding arms slidably coupled to said platform and a base coupled to said frame.

4. The apparatus of claim 1, further comprising an electric motor linked to said plurality of expanding arm pairs.

5. The apparatus of claim 1, further comprising a hydraulic motor including a pump to lift said platform by hydraulic pressure.

6. (canceled)

7. The apparatus of claim 1, further comprising:
one of a weight limit sensor and a weight limit indicator, an imbalance sensor and an imbalance indicator, and a weight limit sensor, a weight limit indicator, an imbalance sensor and an imbalance indicator.

8. The apparatus of claim 1, further comprising:
one of a jack coupled to said holding container, and a holding container lift motor coupled to said holding container, said jack and said holding container lift motor to raise an end of said holding container away from said platform.

9. The apparatus of claim 1, further comprising:
an arm blocked sensor to stop said motor if at least one of said plurality of expanding arms is blocked.

10. The apparatus of claim 1, wherein said holding container includes quick release connectors connected connected to said platform.

11. The apparatus of claim 1, said holding container to rotate between 90° and 135° in relation to said platform.

12. The apparatus of claim 1, further comprising:
a first jack coupled to said plurality of expanding arm pairs to raise and lower said holding container.

13-14. (canceled)

15. The apparatus of claim 12, wherein said first jack is a hydraulic jack.

16. The apparatus of claim 15, said hydraulic jack including one of a removable handle and a removable foot pedal for pumping said jack to lift said platform by hydraulic pressure.

17. The apparatus of claim 12, wherein said first jack is a scissor jack, said scissor jack having a screw drive to force connecting ends of said plurality of expanding arm pairs to one of move apart and move toward each other, said screw drive coupled to a removable handle.

18. The apparatus of claim 12, further comprising:
a rechargeable power source, and one of a weight limit sensor and a weight limit indicator, an imbalance sensor and an imbalance indicator, and a weight limit sensor, a weight limit indicator, an imbalance sensor and an imbalance indicator.

19. The apparatus of claim 12, further comprising:
one of a second jack coupled to said holding container, and a holding container lift motor coupled to said holding container, said second jack and said holding container lift motor to raise an end of said holding container away from said platform.

20. The apparatus of claim 12, further comprising:
a rechargeable power source, and
an arm blocked sensor to stop said motor if at least one of said plurality of expanding arm pairs is blocked.

21. The apparatus of claim 12, wherein said holding container includes quick release connectors to said platform.

22. The apparatus of claim 12, said holding container to rotate between 90° and 135° in relation to said platform.

23. The apparatus of claim 12, said holding container to rotate between 90° and 225° in relation to said platform.

24. An apparatus comprising:
a wheelbarrow, the wheelbarrow including:
a holding container hingably coupled to a platform,
a plurality of expanding arm pairs coupled to said platform and a frame,
a wheel set coupled to said frame, said frame having a support portion and a handle portion, said support portion to rest on a surface,
a motor linked to said plurality of expanding arm pairs to raise and lower said holding container, said plurality of expanding arm pairs raise said platform to at least a height of a dumpster,
a rechargeable power source to drive said motor, and
a controller coupled to said motor and said rechargeable power source to control said motor,
wherein said holding container can rotate from said platform to dump contents within said holding container, and said holding container can rotate from said platform greater than 90°.

25. The apparatus of claim 24, further comprising:
at least one handle coupled to said holding container, and
a wheel lock to lock in place at least one wheel of said wheel set.

26. The apparatus of claim 24, said plurality of expanding arm pairs slidably coupled to said platform and a base coupled to said frame.

27. The apparatus of claim 24, wherein said motor is one of a hydraulic motor and an electric motor.

28. The apparatus of claim 24, wherein said motor is a hydraulic motor including a pump to lift said platform by hydraulic pressure.

29. (canceled)

30. The apparatus of claim 24, further comprising:
one of a weight limit sensor and a weight limit indicator, an imbalance sensor and an imbalance indicator, and a weight limit sensor, a weight limit indicator, an imbalance sensor and an imbalance indicator.

31. The apparatus of claim 2424, further comprising:
one of a jack coupled to said holding container, and a holding container lift motor coupled to said holding container, said jack and said holding container lift motor to raise an end of said holding container away from said platform.

32. The apparatus of claim 24, further comprising:
an arm blocked sensor to stop said motor if at least one of said plurality of expanding arm pairs is blocked.

33. The apparatus of claim 24, wherein said holding container includes quick release connectors connected connected to said platform.

34. The apparatus of claim 24, said holding container to rotate between 90° and 135° in relation to said platform.

35. (canceled)

36. The apparatus of claim 4, further comprising:
a rechargeable power source to drive said electric motor and
a controller coupled to said electric motor and said rechargeable power source to control said electric motor.

37. The apparatus of claim 1, further comprising:
a motor coupled to at least two of the plurality of wheels, and a power source coupled to the motor,
wherein the motor to drive the wheels.

38. The apparatus of claim 24, further comprising:
a motor coupled to the wheel set, and a power source coupled to the motor,
